(19) United States
(12) Patent Application Publication
(10) Pub. No.: US 2007/0126269 A1
(43) Pub. Date: Jun. 7, 2007

(54) Seat for motorcycles

(76) Inventor: Randy Chipkar, Mississauga (CA)

Correspondence Address: YOUNG & BASILE, P.C., 3001 WEST BIG BEAVER ROAD, SUITE 624, TROY, MI, 48084, US

(21) Appl. No.: 11/604,443

(22) Filed: Nov. 27, 2006

Related U.S. Application Data
(60) Provisional application No. 60/741,603, filed on Dec. 2, 2005.

(51) Int. Cl. B60N 2/38; B60K 28/00; B62K 11/00

(52) U.S. Cl. 297/195.1; 180/219; 280/288.4; 280/304.3; 180/271

(57) ABSTRACT

An improved seat is disclosed. The seat is of the type incorporated in use in a motorcycle. The improvement comprises electromagnetic shielding material incorporated into said seat and adapted to shield an operator of said motorcycle at least in part from electromagnetic energy produced thereby in use.

### RELATED APPLICATIONS

This application is a utility application claiming priority to a provisional application; U.S. Application Ser. No. 60/741,603 filed under attorney docket no. MBT-177-A on Dec. 2, 2005, currently pending. The content of the U.S. Patent Ser. No. 60/287,940 is incorporated herein by reference.

### FIELD OF THE INVENTION

The present invention relates to the field of motorcycle seats.

### BACKGROUND OF THE INVENTION

Although opinions vary widely, many persons feel that certain adverse health effects in the general population can be associated with extended exposure to electromagnetic energy in the form of electromagnetic fields (EMF's), waves, etc. One perceived risk relates to the suppression of melatonin production, which is a natural anti-cancer growth hormone.

As well, some experts are now of the opinion that certain people are more sensitive than others to electromagnetic fields. Specifically, some experts believe that certain people suffer from electrical-sensitivity (ES) and/or electromagnetic hyper-sensitivity (EHS), which causes these people to experience symptoms such as fatigue, headaches, weakness and general discomfort.

A great deal of attention has in recent years been directed to wireless cellular telephones, by virtue of the electromagnetic exposure associated with the high frequency transmissions which emanate from such devices. Laptop computers have also become objects of recent heightened concern. Extended exposure to various alternating current (AC) sources of extremely low frequency (ELF) electromagnetic fields have also generated a great deal of attention.

### SUMMARY OF THE INVENTION

Improved seats form several aspects of the invention.

One of such improved seats is of the type having a frame and incorporated in use in a motorcycle type vehicle, the improvement comprising electromagnetic shielding material incorporated into said seat and adapted to shield an operator of said vehicle at least in part from electromagnetic energy produced thereby in use.

Another of such seats is of the type having a frame and incorporated in use in a motorcycle type vehicle having an internal combustion engine of the type having an electrical system producing electromagnetic fields in use, the improvement comprising a layer of electromagnetic shielding material, incorporated into said seat, that is manufactured relatively magnetically soft and positioned and dimensioned to shield an operator of said vehicle at least in part from said electromagnetic fields.

Yet another improved seat is of the type having a frame and incorporated in use in a motorcycle type vehicle having an internal combustion engine of the type having a spark-generating system providing for spark ignition of said engine and driven by an electrical system, the improvement comprising a layer of electromagnetic shielding material, incorporated into said seat, that is manufactured relatively magnetically soft and positioned and dimensioned to shield an operator of said vehicle at least in part from electromagnetic fields produced by said electrical system in use.

Other advantages, features and characteristics of the present invention, as well as methods of operation and functions of the related elements of the structure, and the combination of parts and economies of manufacture, will become more apparent upon consideration of the following detailed description with reference to the accompanying drawings, the latter being briefly described hereinbelow.

### BRIEF DESCRIPTION OF THE DRAWINGS

FIG. 1 is a perspective view of a seat constructed according to a first preferred embodiment of the invention;

FIG. 2 is a side view of the seat of FIG. 1;

FIG. 3 is a perspective view of a seat constructed according to a second preferred embodiment of the invention;

FIG. 4 is a side view of the seat of FIG. 3;

FIG. 5 is a partial view along section 4-4 of FIG. 4;

FIG. 6 is a frontal view of a seat constructed according to a third preferred embodiment of the invention;

FIG. 7 is a bottom plan view of a seat constructed according to a fourth preferred embodiment of the invention; and

FIG. 8 is a partial view along section 7-7 of FIG. 7.

### DETAILED DESCRIPTION

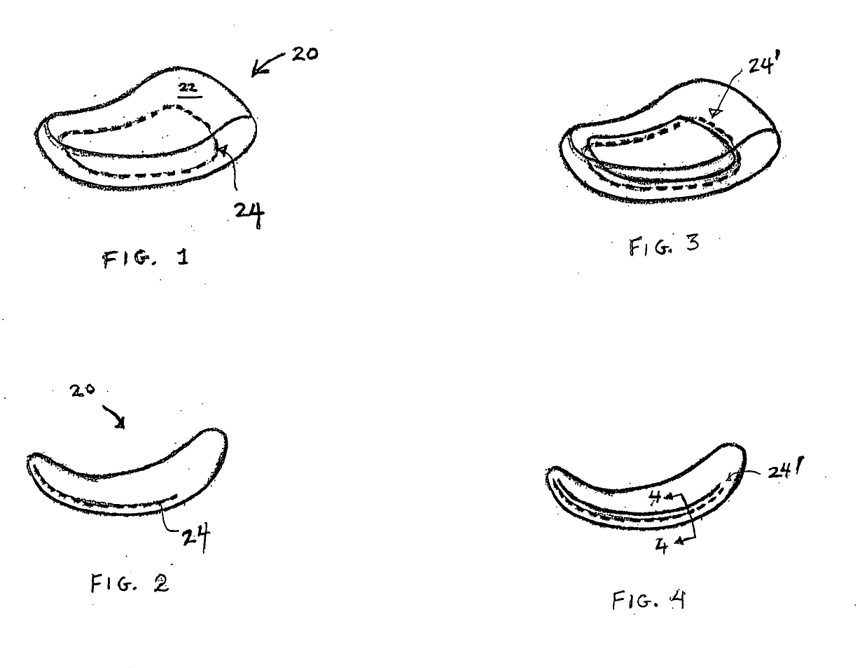

With reference to FIG. 1, a first preferred embodiment of the present invention, an improved motorcycle seat, is illustrated and designated by reference numeral 20.

Generally, seat 20 includes a frame or shell, usually plastic or metal, which supports a foam cushion (neither shown). An outer surface 22 of the seat 20, which may be defined by a vinyl or leather covering, is contoured so as to comfortably support a straddled motorcycle rider in a conventional fashion. The frame, cushion and covering of this seat are of construction conventional in the context of motorcycle seats and thus are not described herein.

An improvement in this seat 20 resides in the interposition of a sheet or layer of electromagnetic shielding material between the frame and the cushion, the sheet being shown in FIG. 1 and FIG. 2 in dotted outline and designated with reference numeral 24. The sheet material 24 illustrated takes the form of a 0.05″ thick sheet of the alloy sold under the trade-mark MUMETAL® by Magnetic Shield Corporation, of Illinois. This particular manufactured material is a hydrogen annealed, high nickel bearing alloy, composed substantially of 80% nickel, 4.4% molybdenum and iron. It is magnetically soft and highly effective for attenuating various electromagnetic fields of AC and DC origin. This is in sharp contrast to conventional materials used for motorcycle seat construction, which are basically transparent to the extremely penetrating nature of electromagnetic fields. The sheet 24 is sufficiently thin to be cut and formed, yet relatively durable. During construction of this improved seat, one of ordinary skill in the art cuts the sheet, using a band saw, stamping machine or other conventional equipment, to conform a blank to the interior perimeter of the empty frame or shell; contours the blank as necessary; and secures same by adhesive, screws or rivets into the shell. Thereafter, the foam cushion and covering are secured to the shell in a conventional manner.

Surprisingly, use of this improved seat 20 on a motorcycle dramatically reduces the extent to which the groin/lower torso of a rider/operator of said motorcycle is exposed to electromagnetic fields at normal operating conditions.

Measurements in the seat area of many stock production motorcycles of today and yesteryear surprisingly reveal the presence of significant electromagnetic energy in the form of an irregular type of EMF oscillating within the extremely low frequency (ELF) bandwith of 30-300 Hz. From stationary idling to increasing normal speeds, the various EMF readings increase dramatically, when read by a single axis AC Gauss meter. For example, a 2005 cruiser type, V-twin stock production motorcycle reveals EMF readings of approximately 15 milliGauss (mG) in the seat area during stationary idling. The same motorcycle when traveling reveals a gradual increase in the seat area EMF strength. When traveling at approximately 25 mph, during normal RPM's, the EMF readings surprisingly displayed an approximate range of 138-142 mG. With the improved seat 20 of the first preferred embodiment installed in place of the stock seat, under the same conditions, field strength readings were attenuated to approximately 1.1 mG during stationary idling and to approximately 14 mG for the 25 mph motion.

For greater certainty, it should be understood that the location where the measurements above were taken roughly corresponded to the position of the pelvis and sensitive vital organs and glands in the groin area of a seated rider.

Similar measurements in the seat area of many motorcycles of different brand, model, year, engine size, etc., reveal various EMF strengths, some as high as 195 mG.

Without intending to be bound by theory, it is believed that sources of EM energy emissions on the motorcycles tested are the electrical system and spark generating system which uses electromagnetic fields to produce high voltage electricity for transmission to the spark plugs. Various types of electromagnetic energies are emitted from various electrical components of a motorcycle including EMF's from a type of alternating/oscillating current and also direct current and in some cases EM waves radiating at various frequencies from spark plug cables, etc. The utility of the improved seat flows from the interposition of the shielding material between the groin of the rider and the various EM energy source components, modules and cables.

Many motorcycle models and designs contain electrical system components, including the battery and electrical cables, directly underneath the seat of the rider. In motorcycles of this type tested, use of the improved seat 20 resulted in a consistent and substantial attenuation of EMF readings in the groin area, typically by about 90%.

Motorcyclists concerned about EMF exposure would benefit from the dramatic reduction of stray electromagnetic fields provided by this improved seat.

A second preferred embodiment of the invention is shown in FIG. 3 and FIG. 4. This embodiment differs from that shown in FIG. 1 and FIG. 2 in that it includes a multi-layered or laminated structure 24′ in the place of the layer 24 of FIG. 1, to further enhance and tailor attenuation of various motorcycle EMF's. The layer 24′ is shown schematically in FIG. 5, and can take the form of multiple magnetically soft sheets or foils forming sublayers, amalgamated together without separation layers. The sheets or foils can be affixed to each other by any suitable method except those involving heating, such as welding, as heating may adversely effect some characteristics of previously annealed alloys.

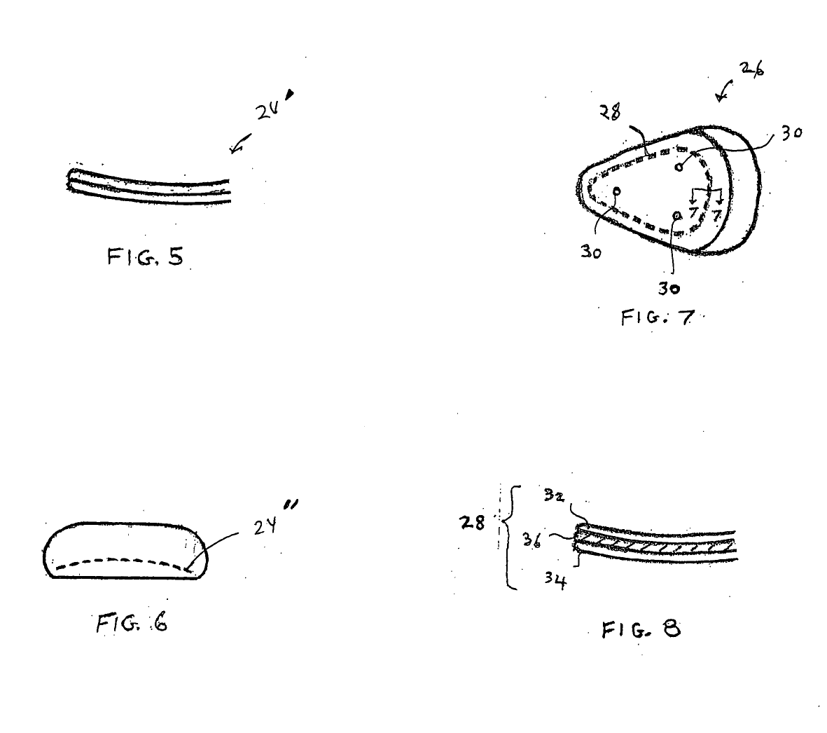

A third preferred embodiment of the invention is shown in FIG. 6, and differs from those previously described in the shape of its interior shield or layer 24″, said shield 24″ being curved downwardly, generally towards the electromagnetic field source, to provide a more effective EMF re-direction path to further enhance attenuation.

A fourth preferred embodiment of the invention is shown in FIG. 7. This figure shows another improved motorcycle seat 26, substantially similar to that illustrated in FIG. 1 and FIG. 2, but differing in that herein a sheet 28 of electromagnetic shielding material is secured by rivets 30 to form an underside of the seat 26.

In this seat, sheet 28 of shielding material takes the form of a multi-layered plate structure, as shown in FIG. 8, wherein layers 32, 34 of electromagnetic shielding MUMETAL® material are separated by a layer 36 of non-conductive plastic ( 1/16″ to ⅛″ thick) to enhance attenuation.

While but four preferred embodiments of the present invention have been herein shown and described, it will be understood that various changes may be made.

Firstly, whereas in the seats illustrated in FIGS. 1-8 the outer perimeter of the shielding material substantially corresponds to the periphery of the underside of the seat when viewed in plan, this is not always necessary. This arrangement is suitable for structures wherein, as previously discussed, the EM energy producing electrical components and cables are located directly underneath the seat. In structures where EM energy producing electrical components were offset somewhat, for example, below and longitudinally frontwardly from the seat, different shielding material configurations might be employed, to maintain maximum shielding efficiency, and in these cases, the outer perimeter of the shielding material will be adapted to conform to the periphery of the seat when viewed from the location of the EM energy producing component(s).

As well, seats of varied style and having varied mounting hardware arrangements can be provided, so as to permit seats according to the present invention to be conveniently mounted on any chosen motorcycle without alteration to the mounting hardware thereof or impact upon the aesthetics or ride comfort.

As well, whereas the preferred embodiments illustrated each reference the use of MUMETAL® alloy, other alloys can be substituted therefor. There are many different brands of specifically manufactured, relatively high nickel bearing, magnetically soft alloys available in different thickness from various companies. Further brand or trade name examples are HIPERNOM® as sold by Carpenter Technology Corporation of Pennsylvania, MAGNIFER® 7904 as sold by EFI Corporation of New Jersey, CO-NETIC™ also sold by the Magnetic Shield Corporation of Illinois, etc. All of these alloys are substantially nickel (75-85%), molybdenum (3-6%) and iron, and provide effective electromagnetic field attenuation.

Furthermore, the sheet or layer may be substituted for a compound material such as resins, metalized plastics, wire weaves, laminated composites, etc., designed specifically for dramatic EMF attenuation. As well, various layers of different thickness may be used to tailor attenuation, and the layers may be separated by electrically conductive or non-conductive material.

As well, whereas FIGS. 1-8 show motorcycle seats, persons of ordinary skill in the art will readily appreciate that seats of this structure could be employed in use with other hybrid motorcycle type vehicles such as ATV's (all-terrain vehicles), trikes, etc.

Moreover, whereas the description includes reference to an electrical spark generating system, it is contemplated that the invention extends to other EM energy-producing structures, components, modules, cables, etc. in close proximity to and/or located beneath the seat, such as might be found on electric motorcycles or on other combustion motorcycles incorporating other direct ignition systems, multiple coils, control modules, relays, batteries, etc.

Further, whereas the magnetically soft material is indicated herein to form an added layer to an otherwise conventional seat, the electromagnetic shielding material could be substituted in whole or in part for other materials in an otherwise conventional seat, i.e. the shielding material could form, in whole or in part, the frame or shell, cushion or cover of an improved seat.

As well, whereas specific shield mounting techniques, such as adhesives, screws and rivets are shown, it will be understood that modifications thereto could be made.

It will be understood that these modifications, and others which may be apparent to persons of ordinary skill in the art, may be made without departing from the spirit or scope of the invention. Accordingly, the scope of the present invention should be understood as being limited only by the claims appended hereto, purposively construed.

In the previous description, and in the following claims, the term “shielding” should be understood to encompass EMF deflection, re-direction, absorption, reduction, etc.

As well, in the previous description and in the following claims, the term “electrical system” of the motorcycle type vehicle should be understood to encompass, inter alia, its battery, battery cables, modules, relays, etc.

What is claimed is:

1. An improved seat of the type having a frame and incorporated in use in a motorcycle type vehicle, the improvement comprising electromagnetic shielding material incorporated into said seat and adapted to shield an operator of said vehicle at least in part from electromagnetic energy produced thereby in use.

2. An improved seat of the type having a frame and incorporated in use in a motorcycle type vehicle having an internal combustion engine of the type
having an electrical system producing electromagnetic fields in use, the improvement comprising a layer of electromagnetic shielding material, incorporated into said seat, that is manufactured relatively magnetically soft and positioned and dimensioned to shield an operator of said vehicle at least in part from said electromagnetic fields.

3. An improved seat of the type having a frame and incorporated in use in a motorcycle type vehicle having an internal combustion engine of the type
having a spark-generating system providing for spark ignition of said engine and
driven by an electrical system, the improvement comprising a layer of electromagnetic shielding material, incorporated into said seat, that is manufactured relatively magnetically soft and positioned and dimensioned to shield an operator of said vehicle at least in part from electromagnetic fields produced by said electrical system in use.

4. A seat according to claim 2, wherein the outer perimeter of the layer substantially corresponds to an outer periphery of the seat frame when viewed in plan.

5. A seat according to claim 2, wherein the outer perimeter of the layer substantially corresponds to an interior periphery of the seat frame when viewed in plan.

6. A seat according to claim 2, wherein the layer is secured to the interior topside of the seat frame.

7. A seat according to claim 2, wherein the layer is secured to the underside of the seat frame.

8. A seat according to claim 3, wherein the outer perimeter of the layer substantially corresponds to the periphery of the seat when viewed from said electrical system.

9. A seat according to claim 2, wherein the layer forms the underside of the seat.

10. A seat according to claim 2, wherein the seat frame is formed by said layer.

11. A seat according to claim 2, wherein the layer is comprised of a combination or lamination of sublayers or foils.

12. A seat according to claim 2, wherein the layer presents a concave surface generally downwards toward the electromagnetic fields produced by said electrical system.

13. A seat according to claim 2, wherein the layer is comprised of a combination or lamination of sublayers each separated by a conductive material.

14. A seat according to claim 1, wherein the seat, in use, shields an operator of the motorcycle from 70% or more of the electromagnetic energy that would have otherwise passed through the seat.

15. A seat according to claim 2, wherein the seat, in use, shields an operator of the motorcycle from 70% or more of the electromagnetic fields, produced by said electrical system, that would have otherwise passed through the seat.

16. A seat according to claim 3, wherein the seat, in use, shields an operator of the motorcycle from 70% or more of the electromagnetic fields, produced by said electrical system, that would otherwise have passed through the seat.

17. A seat according to claim 2, wherein the layer is comprised of a lamination of sublayers separated from one another by non-conductive material.
